(19) United States
(12) Patent Application Publication
(10) Pub. No.: US 2026/0110569 A1
(43) Pub. Date: Apr. 23, 2026

(54) MONITORING INTRUSION EVENTS USING OPTICAL FIBERS

(71) Applicant: Network Integrity Systems, Inc., Hickory, NC (US)

(72) Inventors: Cary R. Murphy, Hickory, NC (US); Mark K. Bridges, Hickory, NC (US); Dave E. Cunningham, Conover, NC (US); Trampus L. Landrum, Hickory, NC (US)

(21) Appl. No.: 18/918,871

(22) Filed: Oct. 17, 2024

(51) Int. Cl. G01H 9/00; G08B 13/186

(52) U.S. Cl. CPC G01H 9/004; G08B 13/186

(57) ABSTRACT

In monitoring for intrusion events, a monitoring system is provided buried in the ground which is sensitive to detect vibrations from footsteps. The sensitive systems include a plurality of optical fibers are arranged so that the vibrations cause relative movement of the fibers where the common light signals from the fibers are injected into a multimode mixing fiber which causes an interference pattern to be formed so that measuring the amplitude of a portion of the pattern obtained by extracting a portion of the modes allows movement of the fibers indicative of an intrusion event to be detected.

This invention relates to a method for monitoring for intrusion events at an asset by providing an elongate fiber structure at a suitable location adjacent the asset where the fiber structure is responsive to the intrusion events so that the intrusion events at the asset cause movement of the fiber structure.

Such arrangements are well known and widely used and there are many different systems for monitoring the optical signals within the fiber structure to detect movement.

The term movement as used herein can include actual displacements and/or translation of the structure in one or more directions and can include vibrations of the structure which do not result in translation.

One type of monitoring system includes the use of Distributed Acoustic Sensing (DAS) where vibrations and displacements cause localized shifts in the path length of the optical fiber. This is detected by a high precision optical Time Domain Reflectometer (OTDR). This OTDR is often referred to as a Phase-OTDR or φ-OTDR, and measures changes in the distance between points of Rayleigh backscatter. This however requires highly sensitive and therefore highly expensive monitoring systems. Other systems of a more simple nature can use other techniques for sensing including an alarm system manufactured by the present assignees under the trade mark Sentinel, details of which are available from a number of prior issued patents by the Assignees including U.S. Pat. Nos. 7,333,681 (Murphy) issued Feb. 19, 2008, 7,403,675 (Murphy) issued Jul. 22, 2008, and 7,092,586 which describe a system for securing Multimode (MM) fibers and U.S. Pat. No. 7,142,737 (Murphy) issued Nov. 28, 2006 which describes a system for securing Single Mode (SM) fibers. The disclosures of each of the above patents are incorporated herein by reference.

In each of these systems, an optical signal is transmitted along a fiber and the signal received at a receiver which extracts a received signal which can have different characteristics relative to the transmitted signal due to movement of the fiber. The received signal is thus analyzed in a light signal analysis system to extract a signal indicative of any changes in characteristics of the light signal. This signal is then itself analyzed to determine whether the characteristics have changed sufficiently to indicate that a movement of the fiber indicative of an attempt to intrude into, or disturb, the fiber has occurred. The system further includes a control and alarm system which controls the system and an alarm in the event that an intrusion or disturbance has been found.

The arrangement and location of the components can vary widely with the receiver located at the same end as the transmitter or at an opposed end. The alarm and control system can also be located at different positions in the system. Communication of data between the components can be carried out in different ways. Many different constructions and techniques for this system are well known to persons skilled in the art and can be determined from one or more of the above patents of the Assignees.

An example of an arrangement is shown in U.S. Pat. No. 7,706,641 issued Apr. 27, 2010 by the present Applicants which describes in detail the monitoring system used in the present application, the disclosure of which is incorporated herein by reference. This patent describes that some or all of the optical fibers of a single-mode or multi-mode cable are monitored for intrusion by transmitting through the fibers a signal which can be analyzed for changes in its characteristics which are indicative of movement as a prelude to an intrusion event.

These arrangements however have some limitations where the movements to be detected are small such as vibrations caused in a fiber structure buried in the ground adjacent a perimeter of the asset such as alongside a perimeter fence.

It is one object of the present invention therefore to provide a modified system for detecting such small movements or vibrations which is highly responsive but of reduced complexity relative to the high cost DAS system above.

### SUMMARY OF THE INVENTION

According to the invention therefore there is provided method for monitoring for intrusion events at an asset comprising:
providing an elongate fiber structure including a plurality of optical fibers extending longitudinally of the fiber structure;
locating the fiber structure in a position relative to the asset which is responsive to the intrusion events so that the intrusion events at the asset cause movement of the fibers of the fiber structure;
locating the plurality of optical fibers in the fiber structure so that the movement causes relative movement of at least one of the optical fibers which is different from the movement of at least one other one of the optical fibers;
wherein the light signals in the plurality of optical fibers are analyzed for detection of an intrusion event by:
   transmitting monitoring light signals along the plurality of optical fiber where the light signals transmitted along the plurality of fibers have the same wavelength;
   combining the light signals from the plurality of optical fibers into a common light signal;
   injecting the common light signal from the plurality of optical fibers into a multimode mixing fiber;
   where transmission of the same wavelength in the optical fibers causes an interference pattern containing constructive and destructive interference between the light signals generated by the relative movement of said at least one of the optical fibers which is different from the movement of said another one of the optical fibers;
   extracting a signal from the multimode fiber;
   and analyzing changes in the extracted signal from the multimode fiber to detect changes movement of the fiber structure indicative of an intrusion event.

In some cases, for ease of installation, the fiber structure includes a container containing the fibers within a common structure.

In other cases, the fiber structure comprises individual fibers installed in proximity to each extending other along an area to be monitored. This can include a tape or other flat structure laid in the ground holding the fibers at predetermined spaced positions.

Thus the above legacy zone technology is used for perimeter security by mounting the sensing fiber to a fence and monitoring for cuts, climbs, lifts, and other intrusions or threats. These so-called zone systems are historically not sensitive enough for buried applications, therefore the mode sensitive and costly Distributed Acoustic Sensing System is often deployed for that application. A buried sensor based on zone technology and at zone monitoring cost is greatly desired in the market.

A method is thus provided for detecting disturbance of an optical cable of single mode optical fibers network where similar light signals are transmitted along multiple optical fibers to be monitored along the sensor cable. The received monitoring light signals after transmission along the optical cable are analyzed for changes indicative of movement of the optical cable for detecting a physical disturbance. The monitoring light signals at the receive end of the fiber signals are monitored by feeding the signals from the N×1 coupler output fiber into a multi-mode fiber in a manner which causes the generation of interference patterns which cause changes in modal power distribution. These signals are exacerbated or amplified by interference between the identical wavelengths which can be detected by taking a portion only of the modes.

In a system such as that described hereinafter for a multi fiber security system, there is a source of instability caused by many optical signals of precisely the same wavelength being joined together and causing interference. Standard detection methods are problematic as the slightest disturbance to any of the fibers have been found to cause wild fluctuations in the mixing fiber containing combined signals generated by the interference pattern.

It is one object of the invention to provide an alarm system of the above type which exploits the above sensitivity.

Preferably the optical fibers comprise single mode fibers but multimode fibers can also be used.

Preferably the changes in the extracted signal from the multimode fiber are analyzed by taking a portion only of modes from the multimode fiber. The portion can be obtained by a splitter in the manner described in the above 586 patent.

Alternatively the portion is obtained by directing the portion from an end face of the multimode fiber into an end of a single mode fiber at the end of the multimode fiber. In this way the single mode fiber collects the portion of the light signal which it can see at the input end of this single mode fiber and this portion can then be analyzed to obtain the required information to determine if movement of the fiber structure is sufficient to indicate that an intrusion event is occurring. That is the portion can be obtained by directing the portion into a single mode fiber at an end of the multimode fiber. The sensing of a portion only is necessary as this ensures that one part only of the total signal is selected for analysis as that part contains portions of the interference pattern which vary in amplitude as the signals change. The total signal injected from the plurality of fibers as a constant total amplitude, but the amplitude of each portion which contains only part of the total pattern varies widely as the interference pattern varies. In this way the large variations in amplitude are caused by vibrations or motions of the fibers and can be detected by a simple analysis of the amplitude. There is therefore no particular requirement for a particular selected portion of the signal to be detected and the location of the single mode fiber relative to the end face of the multimode does not have any particular requirement provided the size is sufficient to obtain a measurable signal. In practice a location at the center is suitable for ease of manufacture, although an edge location can also work.

In one arrangement, the light signals from the plurality of optical fibers are combined into the common light signal by connecting the ends of the fibers by a coupler. Preferably the common light signal from the coupler is fed into a single mode fiber which feeds into the multimode fiber. That is an end of the single mode fiber carrying all of the signals from the individual optical fibers is attached to an end of the multimode fiber so as to be fed into the end face. Again a location at the center of the multimode fiber can operate in a satisfactory manner and is easy to configure. In one configuration. the output of the N×1 coupler is a solitary single mode (SM) fiber. Typically in a buried, sealed enclosure, the solitary SM fiber will connect to the MM fiber using sealed fiber optic connectors which optically concatenate the two fibers. The SM exiting the coupler and feeding the MM is relatively insensitive to disturbance, thus can be used to return the optical signal for some distance prior to the MM mode mixing portion. The MM mode mixing portion is sensitive to disturbance, less than the multi-fiber sensor but more than the SM feeding it, and care should be taken to isolate or protect it from such disturbance. Preferably this is done by locating it as closely as possible to the receiver/detector.

In another configuration. the output of the N×1 coupler is a solitary multimode (MM) fiber which will also perform the function of the MM mode mixing fiber. Typically in a buried, sealed enclosure, the solitary MM fiber will connect to the SM fiber using sealed fiber optic connectors which optically concatenate the two fibers. The MM mode mixing portion is sensitive to disturbance, less than the multi-fiber sensor but more than the SM feeding it, and care should be taken to isolate or protect it from such disturbance. Preferably this is done by locating it as closely as possible, but at least one meter, to the SM fiber, which then extends the distance to the receiver.

Preferably the fiber structure comprises a cable. This consists of multiple optical fibers contained in a single sheath. Care is taken to choose a cable that is approved for direct burial, while maintaining as much mechanical flexibility and flexure as possible. As such, signals from a very stiff metallic armored cable will be significantly attenuated. Use of a conduit for burial is not optimum.

With regard to the containment which locates, holds and protects the fibers these are located in one body for burial and also for ensuring that they all are exposed to the same vibration. That is the fibers all see the same vibration because the fibers are buried together. In the simplest embodiment they are together in a cable, buried in a trough and covered with dirt, or sand, or the like filler material. When an intruder walks on the ground, the filler material is compressed so as to divert some filler material relative to other parts. However the different location of the individual fibers means that they are diverted or vibrated by different amounts. In some cases, the fibers are contained or enclosed by a flexible enclosure or cable. However in another embodiment the fibers can be separated each from the next but parallel to each other. In this way for example four to six fibers buried 6 inches apart becomes a detection area rather than just the path over the cable.

Thus all or many of the fibers should be vibrated by the footsteps (or other passing object) but they vibrate independently and differently so as to create the different patterns which generate the interference. The cable is not of infinite rigidity, therefore it sees flexure from the footsteps. Provided the fibers do not occupy precisely the same location, that is one is above another and is one next to it the differential movement will occur. Thus typically the farther the fibers are from each other within the containment, the better so that it is undesirable to locate all in one sheath at the center.

That is in one embodiment, the fibers are contained in a cable. However they can also be laid out next to each other in a generally parallel pattern, for example each carried on a common supporting tape.

In one preferred installation arrangement the fiber structure is buried in the ground. The arrangement therein is particularly effective in this situation as it is highly responsive to the small vibrations that are generated by passing impacts on the ground for example caused by foot steps. Thus for example the fiber structure is buried in the ground at or adjacent a perimeter of the asset. This can be on one or both sides of a perimeter fence. The fence itself may include a second or additional monitoring system of a conventional nature of a type used for example in the arrangements described above. In this situation an alarm signal can be emitted in response to one or both of the second monitoring system or the detection of an intrusion event by the system of the present invention. The signals from the fence sensing system and the two sides of the buried sensor may detected in unison or in sequence as a result of the movement of an intruder.

The use of a combination of the buried fiber structures on each side of the fence defining a perimeter of an area to be monitored together with the additional monitoring system on the fence enables the following options:
a—an indication of alarm from one buried structure and the fence system provides an output of a warning if the buried system is triggered and nothing is detected on the fence system;
b—an indication of alarm from one buried structure and the fence system provides an output of a warning that an intruder approached the fence and attempted an intrusion or penetrated by climbing, cutting, fabric lift, or other means;
c—an indication of alarm from one buried structure and the fence system provides an output of a warning that an intruder approached the fence and attempted an intrusion or penetrated by climbing, cutting, fabric lift, or other means including an indication whether the intruder is entering or leaving the area inside the fence depending on which side of the fence the buried structure is triggered;
d—an indication of alarm from both buried structures and the fence system provides an output of a warning that an intruder approached the fence and attempted an intrusion or penetrated by climbing, cutting, fabric lift, or other means including an indication if intruder was entering (and is still present) or leaving depending on the chronological order of the signals.

This arrangement can be used with the sensing method set fort above or can be used with other sensing systems which detect movement of the three separate fiber structures.

Thus in accordance with another aspect of the invention there is provided a method for monitoring for intrusion events at an asset comprising:
providing a perimeter fence;
providing on the fence a first elongate fiber structure including a plurality of optical fibers extending longitudinally of the fiber structure and locating the first fiber structure in a position relative to the fence which is responsive to the intrusion events so that the intrusion events at the fence cause movement of the fibers of the fiber structure;
providing on a first side of the fence buried in the ground adjacent the fence a second elongate fiber structure including a plurality of optical fibers extending longitudinally of the fiber structure and locating the second fiber structure in a position in the ground which is responsive to movement of the ground caused by an intruder which causes movement of the fibers of the second fiber structure;
providing on a second side of the fence buried in the ground adjacent the fence a third elongate fiber structure including a plurality of optical fibers extending longitudinally of the fiber structure and locating the third fiber structure in a position in the ground which is responsive to movement of the ground caused by an intruder which causes movement of the fibers of the third fiber structure;
wherein the light signals in the plurality of optical fibers are analyzed for detection of an intrusion event by:
transmitting monitoring light signals along each of the three fiber structures
extracting signals from each of the three fiber structures;
and analyzing changes in the extracted signal to detect changes movement of each fiber structure indicative of an intrusion event;
wherein the second and third fiber structures are buried in the ground and independently monitored on both sides of the perimeter fence and where there is provided an additional monitoring system on the fence for the first fiber structure and an alarm signal is emitted in response to any or all of the monitoring systems or the detection of intrusion events in unison or in sequence;
and wherein use of a combination of the buried fiber structures and the additional monitoring system on the fence enables the following options:
   a—an indication of alarm from one buried structure and the fence system provides an output of a warning if the buried system is triggered and nothing on the fence system;
   b—an indication of alarm from one buried structure and the fence system provides an output of a warning that an intruder approached the fence and attempted an intrusion or penetrated by climbing, cutting, fabric lift, or other means;
   c—an indication of alarm from one buried structure and the fence system provides an output of a warning that an intruder approached the fence and attempted an intrusion or penetrated by climbing, cutting, fabric lift, or other means including an indication whether the intruder is entering or leaving the area inside the fence depending on which side of the fence contains the buried signal;
   d—an indication of alarm from both buried structures and the fence system provides an output of a warning that an intruder approached the fence and attempted an intrusion or penetrated by climbing, cutting, fabric lift, or other means including an indication if intruder was entering (and is still present) or leaving depending on the chronological order of the signals.

In another installation arrangement, multiple independently monitored instances of the monitor sensor are buried in the ground some distance from each other. This can be accomplished by linear parallel paths, concentric paths, or other as indicated by the need. The arrangement therein is particularly effective in this situation as it is highly responsive to the small vibrations that are generated by passing impacts on the ground for example caused by foot steps. Thus for example the fiber structure is buried in the ground at or adjacent a perimeter of the asset. In this situation an alarm signal can be emitted in response to one or more of the monitoring of the present invention. The signals from the sensors may be detected in unison or in sequence as a result of the movement of an intruder and used to indicate direction of movement of said intruder.

Preferably the changes in the extracted signal from the multimode fiber are obtained by analyzing an amplitude of the intensity of the portion of the common light signal. This optical signal is the outcome of monitoring a portion of the modal distribution that will be present in the multimode mode mixing fiber. The output will be a measure of one dimensional amplitude as it varies over time. As set forth above this amplitude varies as the portion selected is looking at only one part of the interference pattern which part varies as the vibrations vary in the different fibers being fed into the multimode mixing fiber.

Preferably the light signals transmitted along the plurality of fibers are continuous and of constant amplitude. Preferably, to optimize the constructive and destructive interference patterns, in addition to the modal metric mixing and detection, they are continuous wave laser of high stability and narrow spectral width. The output of a zone-based monitoring system such as the Network Integrity Systems product SENTINEL would satisfy that requirement.

In one embodiment, the signals are analyzed by a receiver at a transmit end of the fiber structure. In this case the signals can be fed back to the transmit end by a single return fiber in the fiber structure in which the signals are combined. Or the signals can be fed back to the transmit end by a plurality of return fiber in the fiber structures each carrying the signal from a respective one of said optical fibers.

Alternatively in another installation arrangement the signals can be analyzed by a receiver at a receive end of the fiber structure opposite a transmit end.

According to another optional aspect of the invention there is provided a method for detecting intrusion into one or more optical fibers of an optical fiber cable of the above type wherein the monitoring light signals are transmitted at the transmit end of the telecommunications optical fiber and at the receive end of said fiber the signals are returned along a fiber in the same cable.

According to another optional aspect of the invention there is provided a method for detecting intrusion into one or more optical fibers of an optical fiber cable of the above type wherein the monitoring light signals are transmitted at the transmit end of the telecommunications optical fiber and at the receive end of said fiber the signals are returned along a fiber in a separate (non monitoring) cable.

Preferably the monitor system acts for detecting movement of the fiber at locations along the length of the cable.

Preferably the monitor system acts by providing at least one sensor arrangement for receiving a light signal transmitted through the fibers, detecting a series of received light signals which have been transmitted along the fibers to be monitored; comparing at least some of the received light signals relative to data obtained from previously received ones of the received light signals to detect changes in the received light signals relative to the previously received light signals; and analyzing the changes to determine any changes which are indicative of manipulation of the optical fiber causing movement of a portion thereof along the length thereof.

Preferably the monitor system acts to generate an alarm in response to the detection of any such changes which are indicative of manipulation of the optical fiber causing movement of a portion thereof along the length thereof.

In other cases however the receive input and the transmit output of the monitor signals are connected into the same fiber by use of another device.

Preferably the system is used in conjunction with a fence sensor at the perimeter of the area concerned.

### BRIEF DESCRIPTION OF THE DRAWINGS

One embodiment of the invention will now be described in conjunction with the accompanying drawings in which:

FIG. 1 is a schematic illustration of a first embodiment of the monitoring components of the monitoring system for monitoring vibrations in an underground location.

FIG. 2 is a side elevational view of a fence structure used as a perimeter fence around an area to be monitored including a first monitoring system for monitoring disturbance of the fence structure, a second monitoring system for monitoring vibrations in an underground location adjacent the fence on one side and a third monitoring system for monitoring vibrations in an underground location adjacent the fence on an opposed side.

FIG. 3 is an end elevational view of the fence structure and monitoring system of FIG. 2.

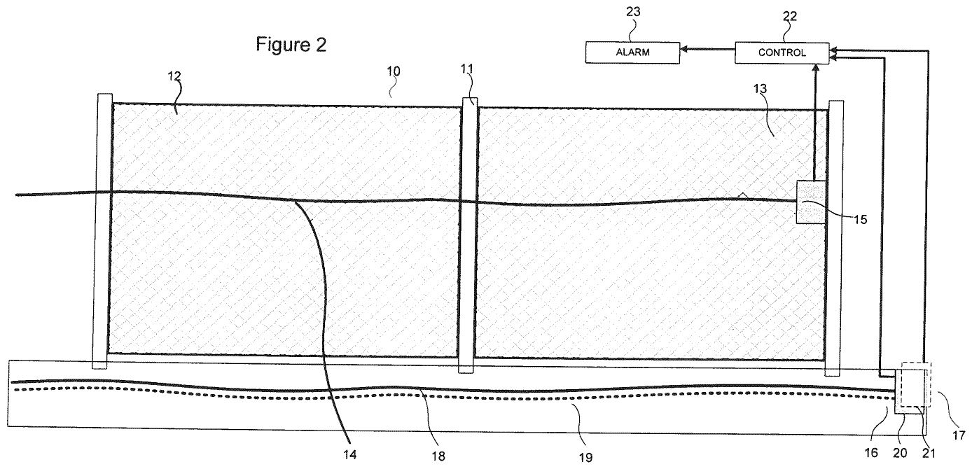

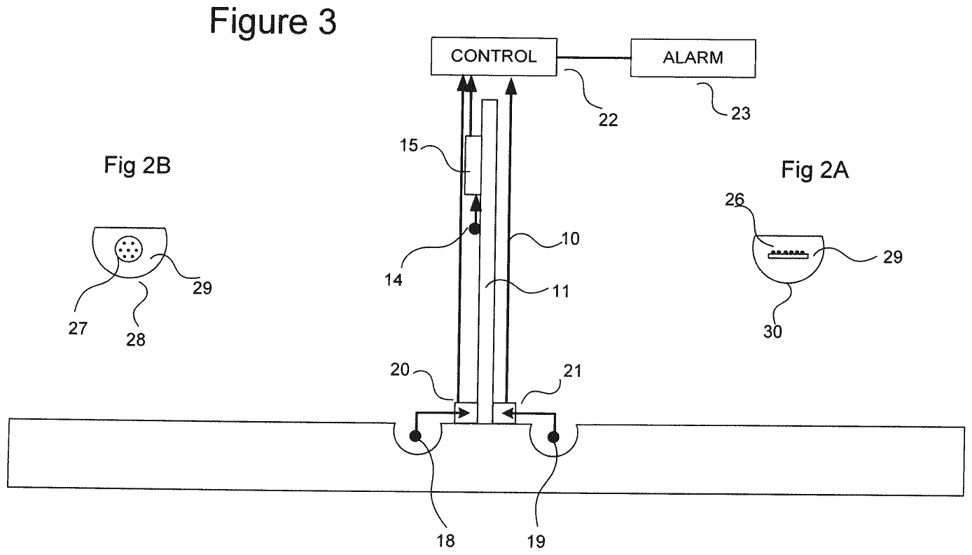

FIG. 2A is a cross-sectional view through one embodiment of a monitoring fiber structure using a support tape in a buried position along side the fence structure of FIG. 2.

FIG. 2B is a cross-sectional view through as second embodiment of a monitoring fiber structure using an enclosing cable structure in a buried position along side the fence structure of FIG. 2.

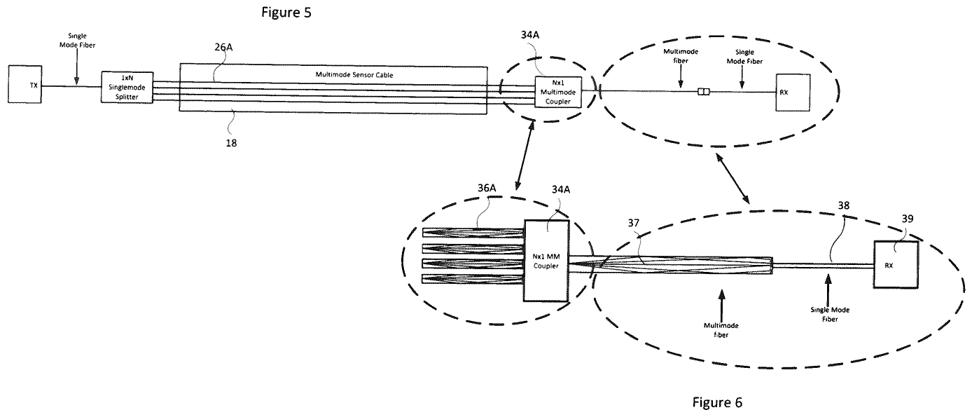

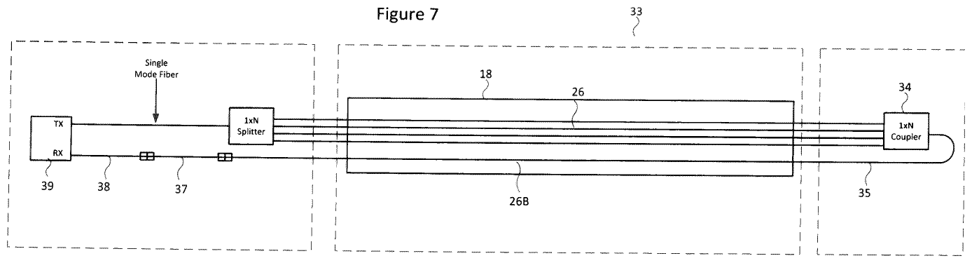

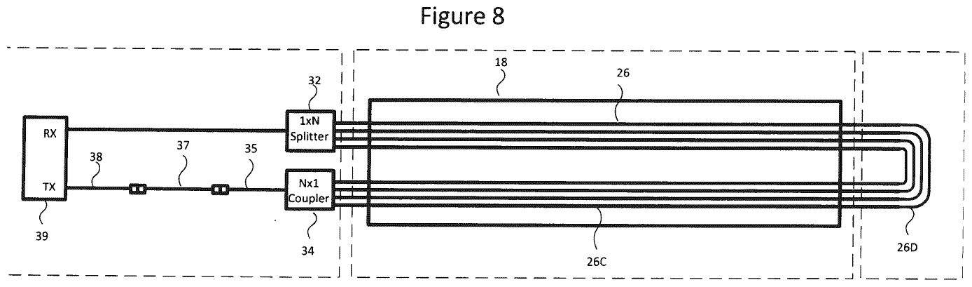

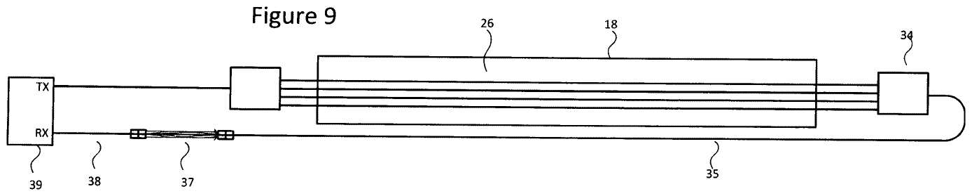

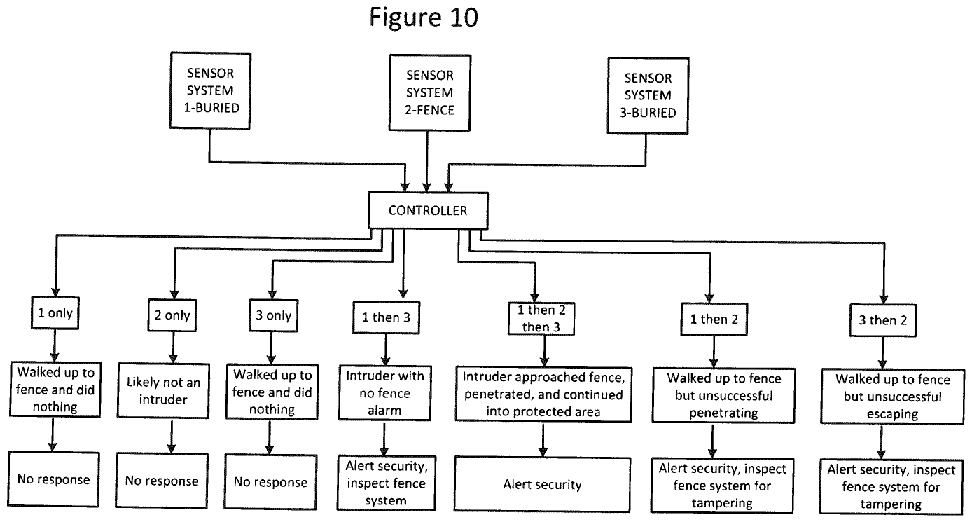

FIG. 4 is an enlarged view of part of the schematic illustration FIG. 3.

FIG. 5 is a schematic illustration of a second embodiment of the monitoring components of the second monitoring system for monitoring vibrations in an underground location adjacent the fence on one side.

FIG. 6 is an enlarged view of part of the schematic illustration FIG. 5.

FIG. 7 is a schematic illustration of a third embodiment of the monitoring components of the second monitoring system for monitoring vibrations in an underground location adjacent the fence on one side.

FIG. 8 is a schematic illustration of a fourth embodiment of the monitoring components of the second monitoring system for monitoring vibrations in an underground location adjacent the fence on one side.

FIG. 9 is a schematic illustration of a fifth embodiment of the monitoring components of the second monitoring system for monitoring vibrations in an underground location adjacent the fence on one side.

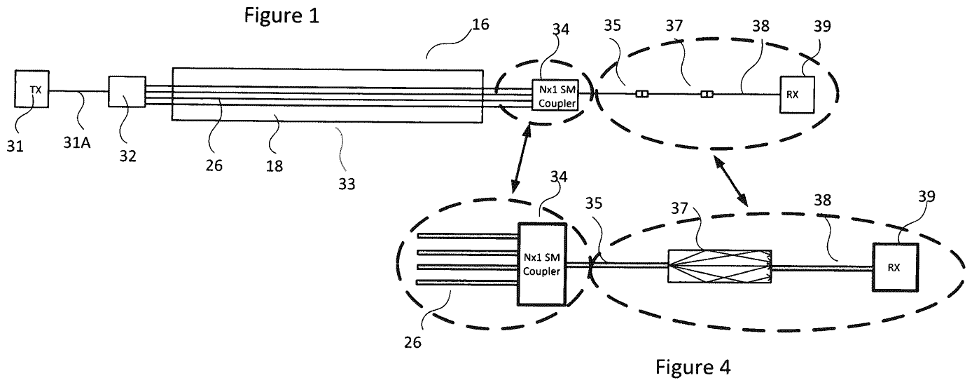

FIG. 10 is a logic diagram showing the analysis of the signals from the three monitoring systems of the embodiment of FIG. 1.

### DETAILED DESCRIPTION

FIGS. 1, 2 and 3 show a system for overcoming a challenge in multi-drop single fiber transmissions where multiple return paths of the same wavelength cause an interferometer instability which is used to amplify signals from small vibrations in buried fibers.

In FIGS. 2 and 3 is shown a monitoring system which includes three components for monitoring activity by intruders at or adjacent a perimeter fence 10. The fence is of a conventional construction with posts 11 and impenetrable sheeting 12 and is monitored by a first monitoring system 13 of a conventional nature as described above which uses fibers 14 and monitoring electronics 15 to detect the relatively large signals generated by movement of the sheeting 12 during a climb or during a cutting action by an intruder.

The second and third components 16 and 17 of the monitoring system include a respective buried fiber structure 18, 19 and monitoring electronics 20, 21. These are of the construction described in detail below and shown best in FIG. 1.

The monitoring electronics of the three systems all supply calculated and detected outputs to a central monitoring and control station 22 which outputs at an alarm 23.

The detection system 16, and symmetrically the detection system 17, illustrated in FIG. 2 uses an elongate fiber structure 18 including a plurality of optical fibers 26 extending longitudinally of the fiber structure.

As discussed above the fiber structure can enclose the fibers in a casing or cable 27 which allows vibration of the ground on footsteps to vibrate the individual fibers as shown in FIG. 2B. thus the cable 27 is buried in a trough 28 and covered with dirt, or sand, or the like filler material 29 up to ground level so that the structure is not visible at ground level. In FIG. 2A, the fibers 26 are carried on a tape structure 29 at spaced positions across the tape so that the tape holds the fibers at the required depth and at a suitable distance apart so that they see different vibration patterns.

The fiber structure 18 is located in a position relative to the fence which is responsive to the intrusion events so that the intrusion events at the fence cause movement of the fibers of the fiber structure. As described above, the plurality of optical fibers are arranged in the fiber structure so that the movement or vibration from footsteps causes relative movement of at least one of the optical fibers 26 which is different from the movement of at least one other one of the optical fibers 26.

As shown in FIG. 1, the light signals in the plurality of optical fibers are analyzed for detection of an intrusion event by transmitting monitoring light signals from a single laser supply 31 so as to have identical characteristics along the plurality of optical fiber so that the light signals transmitted along the plurality of fibers have the same wavelength. The signal is fed into each fiber by a splitter 32.

Downstream of a monitoring zone 33 where the fibers respond to the footsteps, the light signals from the plurality of optical fibers are combined by a second splitter 34 configured as a coupler into a common light signal in a single mode fiber 35.

The common light signal on the fiber 35 from the plurality of optical fibers 26 is injected into a multimode mixing fiber 37 in which the transmission of the same wavelength in the optical fibers causes an interference pattern containing constructive and destructive interference between the light signals. The interference pattern is generated by the relative movement of said at least one of the optical fibers 26 which is different from the movement of said another one of the optical fibers.

One portion of the pattern in the multimode fiber is extracted into a further ingle mode fiber 38 which taps of a signal from the multimode fiber to be fed to a receive section 39 which analyzes changes in the extracted signal from the multimode fiber to detect changes movement of the fiber structure indicative of an intrusion event.

As shown in FIG. 2B, the fiber structure 18 includes a container 27 containing the fibers 26 within a common structure to hold them confined.

As shown in FIG. 2A, the fiber structure comprises individual fibers installed in proximity to each extending along a tape or other support and located along an area to be monitored.

Thus the common light signal from the coupler 34 in the fiber 35 is fed into a multimode fiber 37 which forms a modal metric mixing fiber and the changes in the extracted signal from the multimode fiber 37 are analyzed by taking a portion only of the signal in the multimode fiber which therefore contains a portion only of the interference pattern.

As shown at FIG. 4, the portion or the signal from the multimode fiber is obtained by directing the portion into the single mode fiber 38 at the remote end of the multimode fiber 37.

Thus light enters the single mode fiber 35 carrying the signal of multiple paths such as through distribution coupler 32. The SM fiber 35 is connected to the length of multimode fiber 37, causing a modal distribution within that multimode fiber. This output is then coupled to the SM fiber 38, collecting a portion of the modes, whose distribution is representative of motion on the monitored cable 18. This combines with detector 39 as a system of detection. This is sensitive to movement in the single mode cable being monitored 18 as any motion of the cable causes slight relative changes in the light path and disturbs the modal distribution in the multimode portion. Detector system 39 monitors this signal as detected from the multimode fiber 37 for variations representative of an intrusion.

A stable light source of narrow spectral width is launched through a single mode optical fiber 31A into a 1×N optical splitter 32. The output legs of the splitter feed the fibers 26 of the SM sensing cable 18, which is the sensor itself. This cable 18 is deployed in a location requiring higher sensitivity to detection compared to standard practice. This high sensitivity allows for example detecting footsteps in a buried perimeter security system. The far end of this sensor cable is connected to a N×1 single mode optical coupler 34 that mirrors the input splitter 32. The single output of the coupler 34 is concatenated first to a length of multimode fiber 37, which is then attached to a detection mechanism such as the single mode fiber 38.

Detection occurs when the smaller diameter of the single mode fiber 38 allows a limited distribution of modes within multimode fiber 37 to be sampled. This is sensitive to movement in the single mode cable being monitored as any motion of the cable 18 causes slight changes in the light path length and disturbs the modal interference pattern within the multimode, and therefore the distribution in the multimode portion. Detector system 39 monitors this signal as detected for variations representative of a disturbance.

The single-mode fiber 38 is typically 9μ in core diameter and the length of the multi-mode fiber can be of the order of 1 meter which has worked well and can have a diameter of typically either 50μ or 62.5μ.

A first alternative arrangement is shown in FIGS. 5 and 6 where the monitoring optical fibers 26A of the structure 18 comprise single comprise multimode fibers. These connect to a multimode coupler 34A which directly feeds the length of multimode fiber 37 for the mixing and interference effects described above.

A further alternative arrangement is shown in FIG. 7 where the single mode fiber 35 from the coupler 34 is fed back along the fiber structure 18 as an additional fiber 26B to the receiver 39 at the transmit end. This is convenient in some arrangements and as the fiber 26B in the cable 18 is very insensitive to the vibrations being detected, it does not interfere with the analysis using the multimode fiber 37 as discussed above.

A yet further alternative arrangement is shown in FIG. 8 where the single mode fibers 26 from the structure 18 are each fed back along the fiber structure 18 as an additional sensing fiber 26C to the receiver 39 at the transmit end. In this case the fibers 26 and 26C are all sensing fibers responsive to the vibrations and in this case the coupler 34 is located at the transmit end This is convenient in some arrangements and as the fibers 26C are also responsive to the vibrations, this can increase the sensitivity to the vibrations being detected. The analysis is carried out using the multimode fiber 37 as discussed above.

A yet further alternative arrangement is shown in FIG. 9 where the single mode fiber 35 from the coupler 34 is fed back independently of the fiber structure 18 to the receiver 39 at the transmit end.

As shown in FIGS. 2 and 3, the monitoring system of the present invention including the two separate fiber structures 18 and 19 buried in the ground and independently monitored on both sides of the perimeter fence and including the additional monitoring system on the fence 15 are arranged by the control system 22 so that alarm signal is emitted by alarm 23 in response to any or all of the monitoring systems or the detection of intrusion events in unison or in sequence.

As shown in the logic diagram of FIG. 10 use of a combination of the buried fiber structures and the additional monitoring system on the fence enables the following options:
a—an indication of alarm from one buried structure and the fence system provides an output of a warning if the buried system is triggered and nothing on the fence system;
b—an indication of alarm from one buried structure and the fence system provides an output of a warning that an intruder approached the fence and attempted an intrusion or penetrated by climbing, cutting, fabric lift, or other means;
c—an indication of alarm from one buried structure and the fence system provides an output of a warning that an intruder approached the fence and attempted an intrusion or penetrated by climbing, cutting, fabric lift, or other means including an indication whether the intruder is entering or leaving the area inside the fence depending on which side of the fence contains the buried signal;
d—an indication of alarm from both buried structures and the fence system provides an output of a warning that an intruder approached the fence and attempted an intrusion or penetrated by climbing, cutting, fabric lift, or other means including an indication if intruder was entering (and is still present) or leaving depending on the chronological order of the signals.

1. A method for monitoring for intrusion events at an asset comprising:
providing an elongate fiber structure including a plurality of optical fibers extending longitudinally of the fiber structure;
locating the fiber structure in a position relative to the asset which is responsive to the intrusion events so that the intrusion events at the asset cause movement of the fibers of the fiber structure;
locating the plurality of optical fibers in the fiber structure so that the movement causes relative movement of at least one of the optical fibers which is different from the movement of at least one other one of the optical fibers;
wherein the light signals in the plurality of optical fibers are analyzed for detection of an intrusion event by:
transmitting monitoring light signals along the plurality of optical fiber where the light signals transmitted along the plurality of fibers have the same wavelength;
combining the light signals from the plurality of optical fibers into a common light signal;
injecting the common light signal from the plurality of optical fibers into a multimode mixing fiber;
where transmission of the same wavelength in the optical fibers causes an interference pattern containing constructive and destructive interference between the light signals generated by the relative movement of said at least one of the optical fibers which is different from the movement of said another one of the optical fibers;
extracting a signal from the multimode fiber;
and analyzing changes in the extracted signal from the multimode fiber to detect changes movement of the fiber structure indicative of an intrusion event.

2. The method according to claim 1 wherein said optical fibers comprise single mode fibers or comprise multimode fibers.

3. The method according to claim 1 wherein the fiber structure includes a container containing the fibers within a common structure.

4. The method according to claim 1 wherein the fiber structure comprises individual fibers installed in proximity to each extending other along an area to be monitored.

5. The method according to claim 1 wherein the common light signal from the coupler is fed into a multimode fiber which feeds into the modal metric mixing fiber and the changes in the extracted signal from the multimode fiber are analyzed by taking a portion only of the signal in the multimode fiber which therefore contains a portion only of the interference pattern.

6. The method according to claim 5 wherein the portion is obtained by a splitter.

7. The method according to claim 5 wherein the portion is obtained by directing the portion into a single mode fiber at an end of the multimode fiber.

8. The method according to claim 1 wherein the light signals from the plurality of optical fibers are combined into the common light signal by a coupler.

9. The method according to claim 1 wherein the common light signal from the coupler is fed into a single mode fiber which feeds into the multimode fiber.

10. The method according to claim 1 wherein the fiber structure comprises a cable

11. The method according to claim 1 wherein the fiber structure is buried in the ground.

12. The method according to claim 1 wherein the fiber structure is buried in the ground at or adjacent a perimeter of the asset.

13. The method according to claim 1 wherein the fiber structure is buried in the ground on one or both sides of a perimeter fence.

14. The method according to claim 1 wherein the fiber structure is buried in the ground on at least one side of a perimeter fence and where there is provided an additional monitoring system on the fence and an alarm signal is emitted in response to one or both of the second monitoring system or the detection of an intrusion event.

15. The method according to claim 1 wherein the fiber structure is buried in the ground on at least one side or both sides of a perimeter fence and where there is provided an additional monitoring system on the fence and an alarm signal is emitted in response to one or both of the second monitoring system or the detection of an intrusion event in unison or in sequence.

16. The method according to claim 1 wherein the fiber structure is buried in the ground and independently monitored on both sides of a perimeter fence and where there is provided an additional monitoring system on the fence and an alarm signal is emitted in response to any or all of the monitoring systems or the detection of intrusion events in unison or in sequence.

17. The method according to claim 16 wherein use of a combination of the buried fiber structures and the additional monitoring system on the fence enables the following options:
a—an indication of alarm from one buried structure and the fence system provides an output of a warning if the buried system is triggered and nothing on the fence system;
b—an indication of alarm from one buried structure and the fence system provides an output of a warning that an intruder approached the fence and attempted an intrusion or penetrated by climbing, cutting, fabric lift, or other means;
c—an indication of alarm from one buried structure and the fence system provides an output of a warning that an intruder approached the fence and attempted an intrusion or penetrated by climbing, cutting, fabric lift, or other means including an indication whether the intruder is entering or leaving the area inside the fence depending on which side of the fence contains the buried signal;
d—an indication of alarm from both buried structures and the fence system provides an output of a warning that an intruder approached the fence and attempted an intrusion or penetrated by climbing, cutting, fabric lift, or other means including an indication if intruder was entering (and is still present) or leaving depending on the chronological order of the signals.

18. The method according to claim 1 wherein the signals are analyzed by a receiver at a transmit end of the fiber structure.

19. The method according to claim 18 wherein the signals are fed back to the transmit end by a single return fiber in the fiber structure in which the signals are combined.

20. The method according to claim 18 wherein the signals are fed back to the transmit end by a single return fiber that is separate from the fiber structure in which the signals are combined.

21. The method according to claim 18 wherein the signals are fed back to the transmit end by a plurality of return fiber in the fiber structures each carrying the signal from a respective one of said optical fibers.

22. The method according to claim 1 wherein the signals are analyzed by a receiver at a receive end of the fiber structure opposite a transmit end.

23. The method according to claim wherein the fiber structure includes a plurality of the fiber structures which are independently monitored by monitoring systems and are buried in the ground in sequential locations along a path of travel and an alarm signal is emitted in response to any or all of the monitoring systems providing a detection of intrusion events in unison or in sequence.

24. A method for monitoring for intrusion events at an asset comprising:
providing a perimeter fence;
providing on the fence a first elongate fiber structure including a plurality of optical fibers extending longitudinally of the fiber structure and locating the first fiber structure in a position relative to the fence which is responsive to the intrusion events so that the intrusion events at the fence cause movement of the fibers of the fiber structure;
providing on a first side of the fence buried in the ground adjacent the fence a second elongate fiber structure including a plurality of optical fibers extending longitudinally of the fiber structure and locating the second fiber structure in a position in the ground which is responsive to movement of the ground caused by an intruder which causes movement of the fibers of the second fiber structure;
providing on a second side of the fence buried in the ground adjacent the fence a third elongate fiber structure including a plurality of optical fibers extending longitudinally of the fiber structure and locating the third fiber structure in a position in the ground which is responsive to movement of the ground caused by an intruder which causes movement of the fibers of the third fiber structure;
wherein the light signals in the plurality of optical fibers are analyzed for detection of an intrusion event by:
transmitting monitoring light signals along each of the three fiber structures
extracting signals from each of the three fiber structures;
and analyzing changes in the extracted signal to detect changes movement of each fiber structure indicative of an intrusion event;
wherein the second and third fiber structures are buried in the ground and independently monitored on both sides of the perimeter fence and where there is provided an additional monitoring system on the fence for the first fiber structure and an alarm signal is emitted in response to any or all of the monitoring systems or the detection of intrusion events in unison or in sequence;
and wherein use of a combination of the buried fiber structures and the additional monitoring system on the fence enables the following options:
a—an indication of alarm from one buried structure and the fence system provides an output of a warning if the buried system is triggered and nothing on the fence system;
b—an indication of alarm from one buried structure and the fence system provides an output of a warning that an intruder approached the fence and attempted an intrusion or penetrated by climbing, cutting, fabric lift, or other means;
c—an indication of alarm from one buried structure and the fence system provides an output of a warning that an intruder approached the fence and attempted an intrusion or penetrated by climbing, cutting, fabric lift, or other means including an indication whether the intruder is entering or leaving the area inside the fence depending on which side of the fence contains the buried signal;
d—an indication of alarm from both buried structures and the fence system provides an output of a warning that an intruder approached the fence and attempted an intrusion or penetrated by climbing, cutting, fabric lift, or other means including an indication if intruder was entering (and is still present) or leaving depending on the chronological order of the signals.
